(19) United States
(12) Patent Application Publication
(10) Pub. No.: US 2024/0011879 A1
(43) Pub. Date: Jan. 11, 2024

(54) SPRING, SPRING MATTRESS AND SPRING TESTING METHOD

(71) Applicant: Guangdong Sweetnight Home Co., Ltd., Foshan (CN)

(72) Inventor: Shuimu Huang, Foshan (CN)

(73) Assignee: Guangdong Sweetnight Home Co., Ltd., Foshan (CN)

(21) Appl. No.: 18/059,422

(22) Filed: Nov. 28, 2022

(30) Foreign Application Priority Data
Jul. 11, 2022 (CN) 202210855721.5

(51) Int. Cl. G01N 3/32

(52) U.S. Cl. CPC G01N 3/32; G01N 2203/0019

(57) ABSTRACT

The present disclosure relates to the technical field of springs, and provides a spring, a spring mattress and a spring testing method. The spring includes a helical main body, where the main body is provided with a plurality of spring coils; and a pitch between adjacent spring coils increases gradually from one end of the main body to the other end of the main body. Since the main body of the spring is provided with a plurality of spring coils, and a pitch between adjacent spring coils increases gradually from one end of the main body to the other end of the main body, the spring stressed under an external force can be compressed by stages to provide different feelings for a user, and achieve a better comfort.

### CROSS REFERENCE TO RELATED APPLICATIONS

The present application claims the benefit of Chinese Patent Application No. 202210855721.5 filed on Jul. 11, 2022, the contents of which are incorporated herein by reference in their entirety.

### TECHNICAL FIELD

The present disclosure relates to the technical field of springs, and in particular to a spring, a spring mattress and a spring testing method.

### BACKGROUND

From outside to inside, a conventional spring mattress sequentially includes an outer decorative cloth layer, an inner cushion layer and a spring layer. The spring layer includes a plurality of telescopic springs that are orderly arranged and connected. The inner cushion layer covers the spring layer, and mainly takes a flatting effect, so as not to feel springs in use. The spring layer usually uses helical springs with a same pitch and a same mean diameter. Generally, the telescopic springs each have a wire diameter of 1.8-2.0 mm and an inner diameter of 6-7 cm. Despite better flatness and supporting capacity, the mattress with such a structure is not comfortable.

### SUMMARY

An objective of the present disclosure is to provide a spring, a spring mattress and a spring testing method, to achieve a better comfort in sleeping and provide different levels of support.

To solve the above-mentioned technical problem, the present disclosure provides a spring, including a helical main body having a plurality of spring coils; and a pitch between adjacent spring coils increases gradually from one end of the main body to the other end of the main body.

The spring provided by the present disclosure achieves at least the following beneficial effects:

Since the main body of the spring is provided with a plurality of spring coils, and a pitch between adjacent spring coils increases gradually from one end of the main body to the other end of the main body, the spring stressed under an external force can be compressed by stages to provide different feelings for a user, and achieve a better comfort.

Preferably, the main body has a free height H of 200-300 mm, and a wire diameter d of 1.8-2.2 mm.

Preferably, the spring coils each have a minimum outer diameter D1 of 40-60 mm, and a maximum outer diameter D2 of 60-80 mm.

Preferably, the spring coil with the minimum outer diameter is the spring coil with a minimum pitch.

Preferably, a minimum pitch H1 between the adjacent spring coils is 5-20 mm, a maximum pitch H2 between the adjacent spring coils is 60-80 mm, and a number N of active coils in the spring coils includes nine coils.

To solve the above-mentioned technical problem, the present disclosure further provides a spring mattress, including:

a plurality of the springs described above, the plurality of the springs being arranged in a matrix structure; and

two inner cushion layers, where the plurality of the springs is kept in between the inner cushion layers.

The spring mattress provided by the present disclosure achieves at least the following beneficial effects:

A plurality of the springs are arranged, combined, and cooperated with inner cushion layers to form the spring mattress. The springs are compressed by stages in use, and the compressed height in each stage is different, which provides different experiences for a user, and achieves a better comfort of the mattress.

Preferably, the spring mattress further includes a plurality of positioning cloth pockets, where the plurality of the springs are inserted into the plurality of positioning cloth pockets in one-to-one correspondence.

Preferably, the plurality of the springs are arranged in 20-33 rows and 20-30 columns.

To solve the above-mentioned technical problem, the present disclosure further provides a spring testing method, including the following steps:

S1: test piece processing, comprising trimming protruding parts at upper and lower end surfaces of a spring test piece, such that the end surfaces of the spring are flat;

S2: test piece installation and prestressing: fixing one end of the spring on a base of a universal mechanical tester (UMT), fixing the other end of the spring under a pressure plate, pre-loading a force of 1 N, and reducing the force to zero;

S3: test piece loading: applying a static load with the UMT, where a loading displacement being 80% of an initial height H of the spring; and recording displacement and load data; and

S4: repeating step S3 for five times.

Preferably, the static load is applied at 200 mm/min with the UMT in step S3.

The spring testing method provided by the present disclosure achieves at least the following beneficial effects:

The spring testing method applies a load on a spring through a UMT to record displacement and load data, and applies the load repeatedly to improve the testing accuracy.

Other features and advantages of the present disclosure will be illustrated in the following description, and some of these will become apparent from the description or be understood by implementing the present disclosure.

### BRIEF DESCRIPTION OF THE DRAWINGS

FIG. 1 is a schematic structural view of a spring according to an embodiment of the present disclosure;

FIG. 2 is a schematic structural view of a spring mattress according to an embodiment of the present disclosure; and

FIG. 3 is a schematic view illustrating a rigidity of a spring in stages according to an embodiment of the present disclosure.

Reference numerals:

1: main body, 2: spring coil, and 3: positioning cloth pocket.

### DETAILED DESCRIPTION

The technical solutions in the embodiments of the present disclosure are clearly and completely described below with reference to the drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts should fall within the protection scope of the present disclosure.

In the description of the present disclosure, it needs to be understood the orientation or positional relationships indicated by the terms “center”, “upper”, “lower”, “front”, “rear”, “left”, “right”, “vertical”, “horizontal”, “top”, “bottom”, “inside”, “outside”, etc. are based on the orientation or positional relationship shown in the accompanying drawings, are merely for facilitating the description of the present disclosure and simplifying the description, rather than indicating or implying that an apparatus or element referred to must have a particular orientation or be constructed and operated in a particular orientation, and therefore will not be interpreted as limiting the present disclosure.

In the description of the present disclosure, it should be noted that, unless otherwise clearly specified, meanings of terms “install”, “connected with”, and “connected to” should be understood in a board sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand the specific meanings of the above terms in the present disclosure based on specific situations.

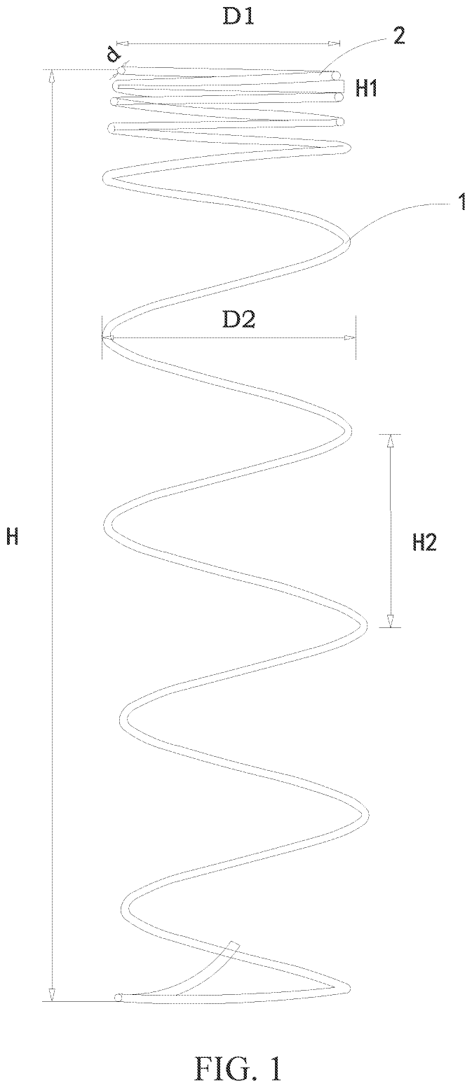

Referring to FIG. 1, a preferred embodiment of the present disclosure provides a spring, including a helical main body 1. The main body 1 is provided with a plurality of spring coils 2. A pitch between adjacent spring coils 2 increases gradually from one end of the main body 1 to the other end of the main body.

To sum up, the spring in the preferred embodiment of the present disclosure has the following beneficial effects:

Since the main body 1 of the spring is provided with a plurality of spring coils 2, and a pitch between adjacent spring coils 2 increases gradually from one end of the main body 1 to the other end of the main body, the spring stressed under an external force can be compressed by stages to provide different feelings for a user, and achieve a better comfort.

In some preferred embodiments of the present disclosure, the main body 1has a free height H of 200-300 mm, and a wire diameter d of 1.8-2.2 mm.

In some preferred embodiments of the present disclosure, the spring coils 2 each have a minimum outer diameter D1 of 40-60 mm, and a maximum outer diameter D2 of 60-80 mm.

In some preferred embodiments of the present disclosure, the spring coil 2 with the minimum outer diameter is the spring coil 2 with a minimum pitch.

In some preferred embodiments of the present disclosure, a minimum pitch H1 between the adjacent spring coils 2 is 5-20 mm, a maximum pitch H2 between the adjacent spring coils 2 is 60-80 mm, and a number N of active coils in the spring coils includes nine coils 2.

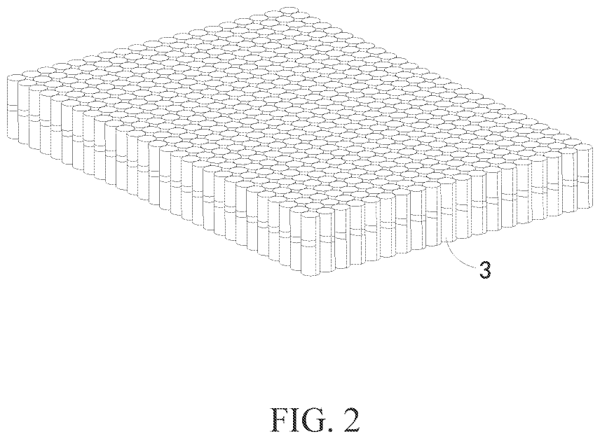

Referring to FIG. 2, the present disclosure further provides a spring mattress, including a plurality of the springs described above and two inner cushion layers (not shown in the figure). The plurality of the springs are arranged in a matrix structure. The two inner cushion layers are configured to clamp the plurality of the springs.

To sum up, the spring mattress in the preferred embodiment of the present disclosure has the following beneficial effects:

A plurality of the springs are arranged, combined, and cooperated with inner cushion layers to form the spring mattress. The springs are compressed by stages in use, and the compressed height in each stage is different, which provides different experiences for a user, and achieves a better comfort of the mattress.

In some preferred embodiments of the present disclosure, the spring mattress further includes a plurality of positioning cloth pockets 3. The plurality of the springs are inserted into the plurality of positioning cloth pockets 3 in one-to-one correspondence. Specifically, the positioning cloth pockets 3 are totally-enclosed cylindrical cloth bags made of a non-woven fabric material.

In some preferred embodiments of the present disclosure, the plurality of the springs are arranged in 20-33 rows and 20-30 columns.

The present disclosure further provides a spring testing method, including the following steps:

S1: Test piece processing: Protruding parts at upper and lower end surfaces of a spring test piece are trimmed, such that end surfaces of the spring are flat.

S2: Test piece installation and prestressing: One end of the spring is fixed on a base of a UMT, while the other end of the spring is fixed under a pressure plate. A force of 1 N is pre-loaded, then the force is reduced to zero.

S3: Test piece loading: A static load is applied with the UMT, a loading displacement being 80% of an initial height H of the spring. Displacement and load data are recorded.

S4: Step S3 is repeated for five times.

In some preferred embodiments of the present disclosure, the static load is applied at 200 mm/min with the mechanical tester in Step S3.

The method is used to test a rigidity characteristic of the spring under stress:

There are A and B types of experimental springs, and different heights of the pocket springs. The A type of spring is 205 mm high, while the B type of spring is 200 mm high. For basic information of the experimental springs, see a table below:

| Component | Spring A | Spring B |
|---|---|---|
| Wire diameter (mm) | 2.2 | 2.2 |
| Number of coils | 9 | 9 |
| Minimum mean diameter(mm) | 50 | 50 |
| Maximum mean diameter(mm) | 70 | 70 |
| Height of pocket spring (mm) | 205 | 200 |
| Free length of spring (mm) | 250 | 250 |
| Minimum pitch (mm) | 10 | 10 |
| Maximum pitch (mm) | 70 | 70 |
| Direction of rotation | Right | Right |

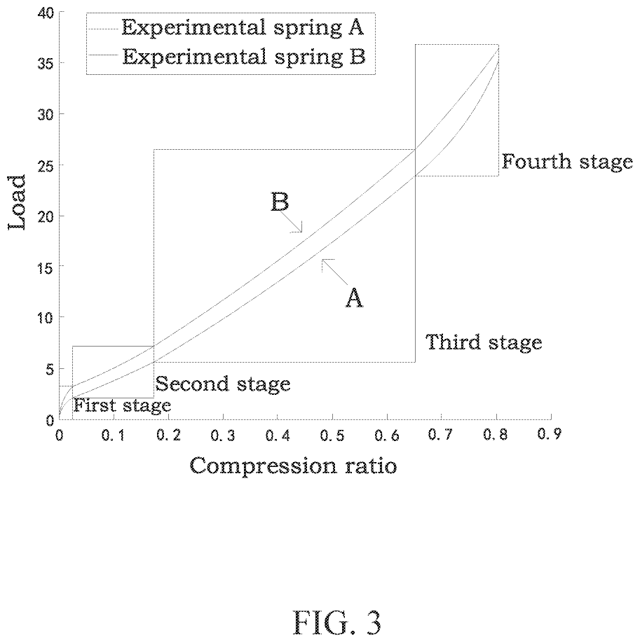

Referring to FIG. 3, the rigidity of the spring in the preferred embodiment of the present disclosure shows a rising trend in stages more obviously, and there are four stages:

In the first stage, the compressed height is 0-2% of the total height of the pocket spring. The rigidity of the spring in this stage is significantly higher than that in most later stages, for the following reasons: (1) The main stressed structure of the spring includes the outer cloth pocket, which is compressed quickly in the later stages and cannot bear any load. (2) Due to pre-loading, the spring bears a load without a displacement. (3) The UMT has a measuring error, and has a high threshold for the magnitude of load measurement.

The spring in this stage is stressed complicatedly. However, as the height is only 2% of the total height of the pocket spring, the effect in actual use can be ignored.

In the second stage, the compressed height is 2-17% of the total height, the rigidity of the spring is low, and the load is mainly borne by a coil combined region, namely a region with a small pitch. Due to the small pitch and large difference in mean diameter in the region, the rigidity is low. Likewise, for the small pitch, only 15% of the total length of the spring is taken up in this stage.

This stage is considered as a main stage that makes the spring in the preferred embodiment of the present disclosure different from the ordinary spring, and a core in design of the spring. Both the mean diameter and the pitch are important adjustable parameters.

In the third stage, the compressed height is 17-65% of the total height, the rigidity is higher than that in the second stage, and 48% of the total length of the spring is taken up. This stage is considered as a main stressed stage of the spring during whole compression. In this stage, the rigidity is high, because coils in upper and lower regions having small mean diameters are combined without a supporting capacity, and the load is mainly borne by a region with a maximum mean diameter. In the region with the maximum mean diameter, due to a large pitch, the spring has a larger helical angle and the higher rigidity.

This stage is the main stressed stage of the spring, on which the supporting capacity is ensured.

In the fourth stage, the compressed height is 65-80% of the compressed height. The rigidity is quickly increased, because the spring has a basically same mean diameter in the region with the maximum mean diameter and coils cannot be combined all the time. When the spring is compressed to the utmost extent, performance of a material used by the spring becomes a main factor to dominate the stress of the spring.

This stage is basically never seen in actual use of the mattress.

To sum up, the spring testing method in the preferred embodiment of the present disclosure has the following beneficial effects:

The spring testing method applies a load on a spring through a UMT to record displacement and load data, and applies the load repeatedly to improve the testing accuracy.

The above are only preferred implementations of the present disclosure. It should be noted that several improvements and replacements may further be made by a person of ordinary skill in the art without departing from the principle of the present disclosure, and such improvements and replacements should also be deemed as falling within the protection scope of the present disclosure.

1. A spring, comprising a helical main body having a plurality of spring coils; and a pitch between adjacent spring coils increases gradually from one end of the main body to the other end of the main body.

2. The spring according to claim 1, wherein the main body has a free height H of 200-300 mm, and a wire diameter d of 1.8-2.2 mm.

3. The spring according to claim 1, wherein the spring coils each have a minimum outer diameter D1 of 40-60 mm, and a maximum outer diameter D2 of 60-80 mm.

4. The spring according to claim 3, wherein the spring coil with the minimum outer diameter is the spring coil with a minimum pitch.

5. The spring according to claim 1, wherein a minimum pitch H1 between the adjacent spring coils is 5-20 mm, a maximum pitch H2 between the adjacent spring coils is 60-80 mm, and an active coil number N of the spring coils is nine coils.

6. A spring mattress, comprising:
a plurality of the springs according to claim 1, the plurality of the springs being arranged in a matrix structure; and
two inner cushion layers, where the plurality of the springs are kept in between the two inner cushion layers.

7. The spring mattress according to claim 6, further comprising a plurality of positioning cloth pockets, wherein the plurality of the springs are inserted into the plurality of positioning cloth pockets in one-to-one correspondence.

8. The spring mattress according to claim 6, wherein the plurality of the springs are arranged in 20-33 rows and 20-30 columns.

9. A spring testing method, comprising the following steps:
S1: test piece processing, comprising trimming protruding parts on upper and lower end surfaces of a spring test piece, such that the end surfaces of the spring are flat;
S2: test piece installation and prestressing, comprising fixing one end of the spring on a base of a mechanical tester, fixing the other end of the spring under a pressure plate, pre-loading a force of 1 N, and reducing the force to zero;
S3: test piece loading, comprising applying a static load with the mechanical tester, where a loading displacement being 80% of an initial height H of the spring; and recording displacement and load data; and
S4: repeating step S3 for five times.

10. The spring testing method according to claim 9, wherein the static load is applied at 200 mm/min with the mechanical tester in step S3.

11. A spring mattress, comprising:
a plurality of the springs according to claim 2, the plurality of the springs being arranged in a matrix structure; and
two inner cushion layers, where the plurality of the springs are kept in between the two inner cushion layers.

12. A spring mattress, comprising:
a plurality of the springs according to claim 3, the plurality of the springs being arranged in a matrix structure; and
two inner cushion layers, where the plurality of the springs are kept in between the two inner cushion layers.

13. A spring mattress, comprising:
a plurality of the springs according to claim 4, the plurality of the springs being arranged in a matrix structure; and
two inner cushion layers, where the plurality of the springs are kept in between the two inner cushion layers.

14. A spring mattress, comprising:
a plurality of the springs according to claim 5, the plurality of the springs being arranged in a matrix structure; and
two inner cushion layers, where the plurality of the springs are kept in between the two inner cushion layers.
